(19) United States
(12) Patent Application Publication
(10) Pub. No.: US 2025/0137811 A1
(43) Pub. Date: May 1, 2025

(54) DRIVABLE SURFACE AND LANE GROUP ESTIMATION

(71) Applicant: TOYOTA JIDOSHA KABUSHIKI KAISHA, Toyota-shi (JP)

(72) Inventor: SHUNSHO KAKU, Mountain View, CA (US)

(21) Appl. No.: 18/499,134

(22) Filed: Oct. 31, 2023

(51) Int. Cl. G01C 21/00; G06N 3/0464

(52) U.S. Cl. CPC G01C 21/3841; G01C 21/3815; G06N 3/0464

(57) ABSTRACT

Systems and methods are provided for determining lane groups for use in autonomous driving. The system can receive probe data of an autonomous vehicle traveling on a roadway and discretize the probe data into a plurality of lateral slices of the roadway. Features can be determined, the features being associated with the plurality of lateral slices. A portion of the plurality of lateral slices can be grouped into a lane group based on the features. Each slice can be classified based on the lane group.

### CROSS-REFERENCE TO RELATED APPLICATIONS

This application is related to co-pending and co-owned U.S. application Ser. No. 18/499,126, filed on Oct. 31, 2023, titled “DRIVABLE SURFACE AND LANE GROUP ESTIMATION” which is incorporated herein by reference in its entirety.

### TECHNICAL FIELD

The present disclosure relates generally to autonomous driving, and in particular, some implementations may relate to generating trajectories to be executed by an autonomous driving system.

### DESCRIPTION OF RELATED ART

Autonomous driving systems have to identify the location of drivable surfaces in order to execute self-driving trajectories. Data can be used to map a roadway in order to determine features of that roadway. These features can assist an autonomous driving system in determining where to traverse the vehicle.

### BRIEF SUMMARY OF THE DISCLOSURE

According to various embodiments of the disclosed technology, a method can comprise receiving probe data of an autonomous vehicle traveling on a roadway; discretizing the probe data into a plurality of lateral slices of the roadway; determining features associated with the plurality of lateral slices; grouping a portion of the plurality of lateral slices into a lane group based on the features; and classifying each slice based on the lane group.

In some embodiments, a CNN network groups the portion of the plurality of lateral slices into the lane group.

In some embodiments, the probe data generates a histogram indicating probabilities of lane boundaries across the plurality of lateral slices.

In some embodiments, each lateral slice comprises five meters of the roadway.

In some embodiments, each slice of the portion of the plurality of lateral slices is classified as a start of the lane group, an interior of the lane group, or an end of the lane group.

In some embodiments, the features comprise hard lane boundaries and soft lane boundaries.

In some embodiments, the method further comprises determining that a slice of the plurality of lateral slices classifies as a transition between lane groups.

In some embodiments, each lane group comprises a left and right road boundary.

According to various embodiments of the disclosed technology, a vehicle control system can comprise a processor and a memory coupled to the processor to store instructions, which when executed by the processor, causes the processor to: receive probe data of an autonomous vehicle traveling on a roadway; discretize the probe data into a plurality of lateral slices of the roadway; generate a histogram indicating probabilities of lane boundaries across the plurality of lateral slices; group a portion of the plurality of lateral slices into a lane group based on the histogram; and classify each slice based on the lane group.

In some embodiments, a CNN network groups the portion of the plurality of lateral slices into the lane group.

In some embodiments, each lateral slice of the plurality of lateral slices comprises five meters of the roadway.

In some embodiments, each slice of the portion of the plurality of lateral slices is classified as a start of the lane group, an interior of the lane group, or an end of the lane group.

In some embodiments, the instructions further cause the processor to determine that a slice of the plurality of lateral slices classifies as a transition between

In some embodiments, each lane group comprises a left and right road boundary.

According to various embodiments of the disclosed technology, a non-transitory machine-readable medium can have instructions stored therein, which when executed by a processor, causes the processor to receive probe data of an autonomous vehicle traveling on a roadway; discretize the probe data into a plurality of lateral slices of the roadway; determine features associated with the plurality of lateral slices; group a portion of the plurality of lateral slices into a lane group based on the features; and determine that one or more slices of the plurality of lateral slices classifies as transitions between lane groups.

In some embodiments, a CNN network groups the portion of the plurality of lateral slices into the lane group.

In some embodiments, the probe data generates a histogram indicating probabilities of lane boundaries across the plurality of lateral slices.

In some embodiments, each lateral slice comprises five meters of the roadway.

In some embodiments, the features comprise hard lane boundaries and soft lane boundaries.

In some embodiments, each lane group comprises a left and right road boundary.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example architecture for estimating drivable surfaces in accordance with one embodiment of the systems and methods described herein.

FIG. 3 illustrates an example workflow for estimating drivable surfaces in accordance with various embodiments.

FIG. 4 illustrates an example workflow for estimating lane groups in accordance with various embodiments

FIG. 5 illustrates an example workflow for generating a road estimation network in accordance with various embodiments.

FIG. 6 illustrates an example classification of lane groups.

FIG. 7 illustrates an example histogram for determining lane boundaries.

FIG. 8 illustrates an example method for determining drivable surfaces in accordance with one embodiment.

FIG. 9 illustrates an example method for determining lane groups in accordance with one embodiment.

FIG. 10 is an example computing component that may be used to implement various features of embodiments described in the present disclosure.

The figures are not exhaustive and do not limit the present disclosure to the precise form disclosed.

### DETAILED DESCRIPTION

Autonomous driving systems can map roadways using various types of data, including satellite data, infrastructure data, and vehicle probe data. Here, vehicle probe data refers to data collected from vehicles, which can include sensor data, GPS data, and environmental data. Conventional autonomous driving systems can identify physical, marked lane boundaries in determining a vehicle's trajectory. However, these systems cannot identify the location of drivable surfaces outside of the marked lane boundaries. For example, markings may be nonexistent at certain road sections (i.e., where a turn is available, where the road becomes one lane, etc.). Furthermore, markings may not be enough to inform a vehicle about drivable surfaces, such as in cases where lanes are blocked off for construction with cones or other physical boundaries. Additionally, conventional systems applying probe data may be inaccurate when the probe data only comprises GPS trace information for vehicles. In order for an autonomous driving system to operate effectively in these situations, simple lane markings are not enough.

The systems and methods described herein can identify a drivable surface based on vehicle probe data, satellite imagery, and road/navigation graphs. Here, road/navigation graphs refer to any graph or trajectory imagery, which can include, but is not limited to, GPS data, infrastructure data, landmark identifications, traffic data, and/or other data related to the navigation of a vehicle. The system can extract a road image from all data and perform lane group estimation. Lane group estimation can refer to classifying segments of road according to specific lane groups. Lane groups can be based on location, number of lanes, whether the road is merging or extending lanes, and/or any structural differences in the segments of road. Lane group estimation can be accomplished by determining lane features from slices or segments of road based on probe data, satellite imagery, and/or road/navigation graphs. Lane features can include, but are not limited to, boundaries, surface type, lane surface type, lane type, and/or lane direction. These features can be input in one or more models to determine one or more lane groups and the corresponding lane boundaries for each lane group and road segment. Each road segment can be classified based on its corresponding lane group. By focusing on the computation of individual slices, the system can make more accurate determinations about the slices together to form a mapping for use in autonomous driving.

The determined lane groups can be applied to determine a road boundary estimation network. This road boundary estimation network can extract road boundary key points from the above sources of data. Here, key points can refer to points on the road that may signify a lane boundary, such as the location of a lane marker, cone, physical boundary, or other boundary to the drivable surface. The key points and lane groups can be used to featurize each segment of road into a histogram illustrating the probabilities of lane boundaries across the road segment. This featurization can be input into a CNN-based network to determine left and right boundary positions for each road segment.

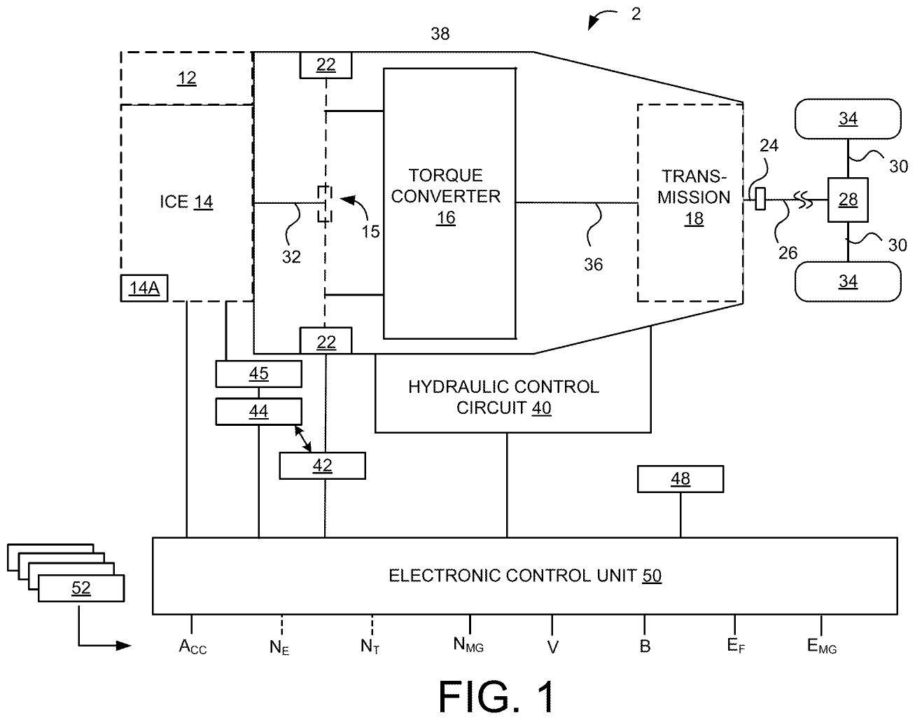

The systems and methods disclosed herein may be implemented with any of a number of different vehicles and vehicle types. For example, the systems and methods disclosed herein may be used with automobiles, trucks, motorcycles, recreational vehicles and other like on- or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for lane group and drivable surface estimation can be implemented in other types of vehicles including gasoline- or diesel-powered vehicles, fuel-cell vehicles, electric vehicles, or other vehicles.

FIG. 1 illustrates a drive system of a vehicle 100 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, vehicle 100 relies on the motive force generated at least by internal combustion engine 14, and a clutch 15 may be included to engage engine 14. In the EV travel mode, vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 2 and is powered electrically via a battery 44. Battery 44 may be implemented as one or more batteries or other power storage devices including, for example, lead-acid batteries, nickel-metal hydride batteries, lithium-ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium-ion batteries, lead acid batteries, nickel cadmium batteries, lithium-ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 100 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in vehicle 100. For example, electronic control unit 50 may receive signals that indicate vehicle operating conditions or characteristics, or signals that can be used to derive vehicle operating conditions or characteristics. These may include, but are not limited to accelerator operation amount, A_{CC}, a revolution speed, NE, of internal combustion engine 14 (engine RPM), a rotational speed, N_{MG}, of the motor 22 (motor rotational speed), and vehicle speed, N_{V}. These may also include torque converter 16 output, NT (e.g., output amps indicative of motor output), brake operation amount/pressure, B, battery SOC (i.e., the charged amount for battery 44 detected by an SOC sensor). Accordingly, vehicle 100 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, E_{F}, motor efficiency, E_{MG}, hybrid (internal combustion engine 14+MG 12) efficiency, acceleration, A_{CC}, etc.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as one example of vehicle systems with which embodiments of the disclosed technology may be implemented. One of ordinary skill in the art reading this description will understand how the disclosed embodiments can be implemented with this and other vehicle platforms.

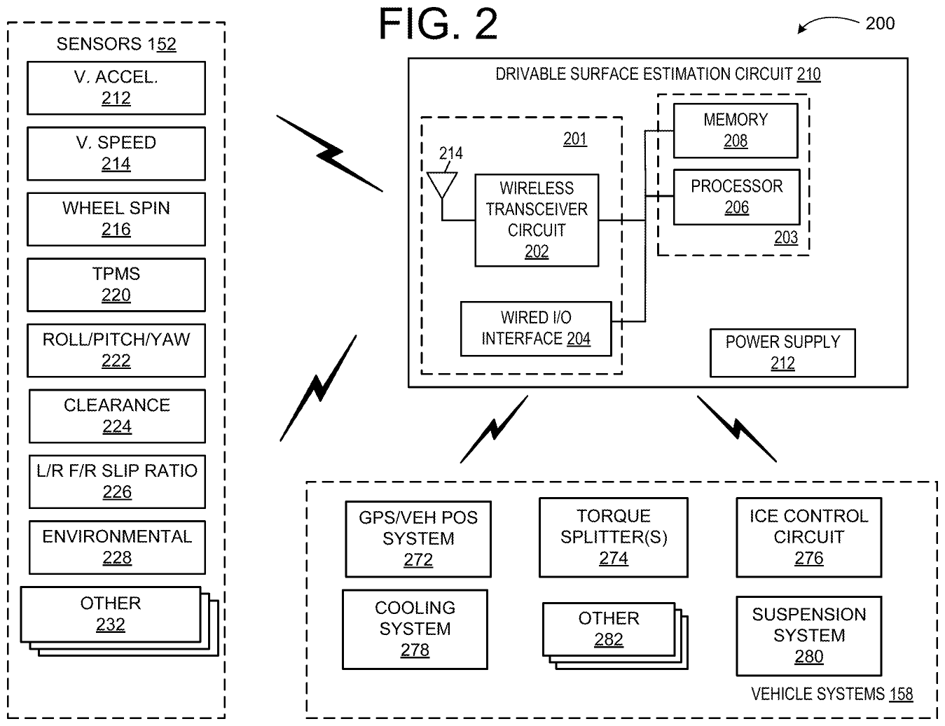

FIG. 2 illustrates an example architecture for determining drivable surfaces in accordance with one embodiment of the systems and methods described herein. In some embodiments, drivable surface estimation system 200 can be implemented in-vehicle to execute while a driver is operating the vehicle. In other embodiments, drivable surface estimation system 200 can operate over a cloud or other network. Referring now to FIG. 2, in this example, drivable surface estimation system 200 includes a drivable surface estimation circuit 210, a plurality of sensors 152 and a plurality of vehicle systems 158.

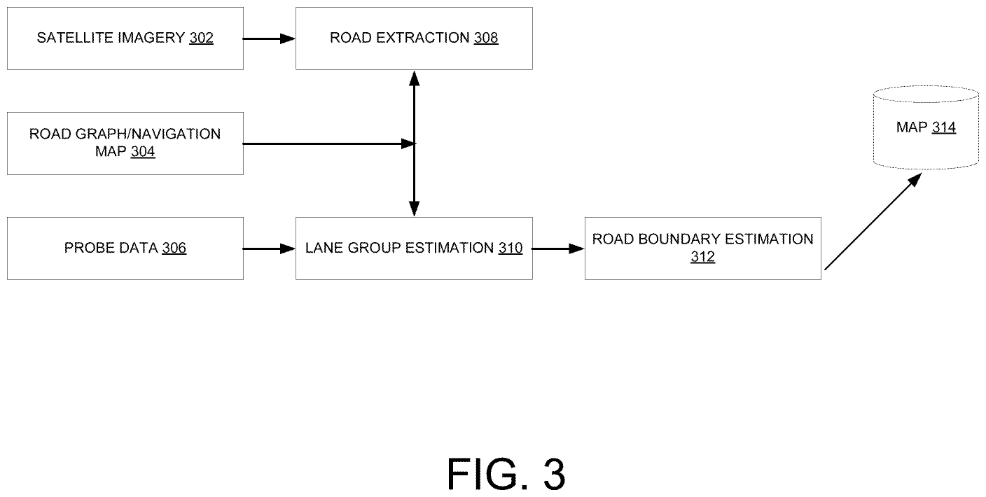

As described further below in FIGS. 3-5, sensors 152 can communicate probe data while the vehicle is in operation. In particular, sensors 152 can include, but are not limited to, image sensors, video sensors, or other environmental sensors. Sensors 152 can communicate this data to drivable surface estimation circuit 210 to determine drivable surfaces while the vehicle is in operation.

Sensors 152 and vehicle systems 158 can communicate with drivable surface estimation circuit 210 via a wired or wireless communication interface. Although sensors 152 and vehicle systems 158 are depicted as communicating with drivable surface estimation circuit 210, they can also communicate with each other as well as with other vehicle systems. Drivable surface estimation circuit 210 can be implemented as an ECU or as part of an ECU such as, for example electronic control unit 50. In other embodiments, drivable surface estimation circuit 210 can be implemented independently of the ECU, such that sensors 152 and vehicle systems 158 can communicate to drivable surface estimation circuit 210 over a network, server or cloud interface. In embodiments where drivable surface estimation circuit 210 operates over a network, drivable surface estimation circuit 210 can execute the architecture described below in FIGS. 3-5 and communicate back to sensors 152 and vehicle systems 158.

Drivable surface estimation circuit 210 in this example includes a communication circuit 201, a decision circuit 203 (including a processor 206 and memory 208 in this example) and a power supply 212. Components of drivable surface estimation circuit 210 are illustrated as communicating with each other via a data bus, although other communication in interfaces can be included. Drivable surface estimation circuit 210 can receive satellite data, navigation data, and/or probe data as described further below in FIG. 3 and input that data into a CNN network through decision circuit 203. Decision circuit 203 can execute lane group estimation and road boundary estimation. Lane group estimation can be used to classify portions of a roadway into lane groups. Road boundary estimations can be used to generate a road boundary network and map indicating drivable surfaces. Drivable surface estimation circuit 210 can use these determinations to determine whether to alter operating characteristics of the vehicle. Drivable surface estimation circuit 210 can communicate with vehicle systems 158 through communication circuit 201 in response to the determined road boundary network and

Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store the calibration parameters, images (analysis or historic), point parameters, instructions and variables for processor 206 as well as any other suitable information. Memory 208 can be made up of one or more modules of one or more different types of memory and may be configured to store data and other information as well as operational instructions that may be used by the processor 206 to drivable surface estimation circuit 210.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up a drivable surface estimation circuit 210.

Communication circuit 201 either or both a wireless transceiver circuit 202 with an associated antenna 205 and a wired I/O interface 204 with an associated hardwired data port (not illustrated). Communication circuit 201 can provide for V2X and/or V2V communications capabilities, allowing drivable surface estimation circuit 210 to communicate with edge devices, such as roadside unit/equipment (RSU/RSE), network cloud servers and cloud-based databases, and/or other vehicles via a network. For example, V2X communication capabilities allows drivable surface estimation circuit 210 to communicate with edge/cloud devices, roadside infrastructure (e.g., such as roadside equipment/roadside unit, which may be a vehicle-to-infrastructure (V21)-enabled streetlight or cameras, for example), etc. Local drivable surface estimation circuit 210 may also communicate with other connected vehicles over vehicle-to-vehicle (V2V) communications.

As used herein, “connected vehicle” refers to a vehicle that is actively connected to edge devices, other vehicles, and/or a cloud server via a network through V2X, V21, and/or V2V communications. An “unconnected vehicle” refers to a vehicle that is not actively connected. That is, for example, an unconnected vehicle may include communication circuitry capable of wireless communication (e.g., V2X, V21, V2V, etc.), but for whatever reason is not actively connected to other vehicles and/or communication devices. For example, the capabilities may be disabled, unresponsive due to low signal quality, etc. Further, an unconnected vehicle, in some embodiments, may be incapable of such communication, for example, in a case where the vehicle does not have the hardware/software providing such capabilities installed therein.

As this example illustrates, communications with drivable surface estimation circuit 210 can include either or both wired and wireless communications circuits 201. Wireless transceiver circuit 202 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 205 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by drivable surface estimation circuit 210 to/from other entities such as sensors 152 and vehicle systems 158.

Wired I/O interface 204 can include a transmitter and a receiver (not shown) for hardwired communications with other devices. For example, wired I/O interface 204 can provide a hardwired interface to other components, including sensors 152 and vehicle systems 158. Wired I/O interface 204 can communicate with other devices using Ethernet or any of a number of other wired communication protocols whether standardized, proprietary, open, point-to-point, networked or otherwise.

Power supply 212 can include one or more of a battery or batteries (such as, e.g., Li-ion, Li-Polymer, NiMH, NiCd, NiZn, and NiH₂, to name a few, whether rechargeable or primary batteries), a power connector (e.g., to connect to vehicle supplied power, etc.), an energy harvester (e.g., solar cells, piezoelectric system, etc.), or it can include any other suitable power supply.

Sensors 152 can include, for example, sensors 52 such as those described above with reference to the example of FIG. 1. Sensors 152 can include additional sensors that may or may not otherwise be included on a standard vehicle 10 with which the drivable surface estimation system 200 is implemented. In the illustrated example, sensors 152 include vehicle acceleration sensors 212, vehicle speed sensors 214, wheelspin sensors 216 (e.g., one for each wheel), a tire pressure monitoring system (TPMS) 220, accelerometers such as a 3-axis accelerometer 222 to detect roll, pitch and yaw of the vehicle, vehicle clearance sensors 224, left-right and front-rear slip ratio sensors 226, and environmental sensors 228 (e.g., to detect salinity or other environmental conditions). Additional sensors 232 can also be included as may be appropriate for a given implementation of drivable surface estimation system 200.

Vehicle systems 158 can include any of a number of different vehicle components or subsystems used to control or monitor various aspects of the vehicle and its performance. In this example, the vehicle systems 158 include a GPS or other vehicle positioning system 272; torque splitters 274 that can control distribution of power among the vehicle wheels such as, for example, by controlling front/rear and left/right torque split; engine control circuits 276 to control the operation of engine (e.g. Internal combustion engine 14); cooling systems 278 to provide cooling for the motors, power electronics, the engine, or other vehicle systems; suspension system 280 such as, for example, an adjustable-height air suspension system, or an adjustable-damping suspension system; and other vehicle systems 282.

Communication circuit 201 can be used to transmit and receive information between drivable surface estimation circuit 210 and sensors 152, and drivable surface estimation circuit 210 and vehicle systems 158. Also, sensors 152 may communicate with vehicle systems 158 directly or indirectly (e.g., via communication circuit 201 or otherwise).

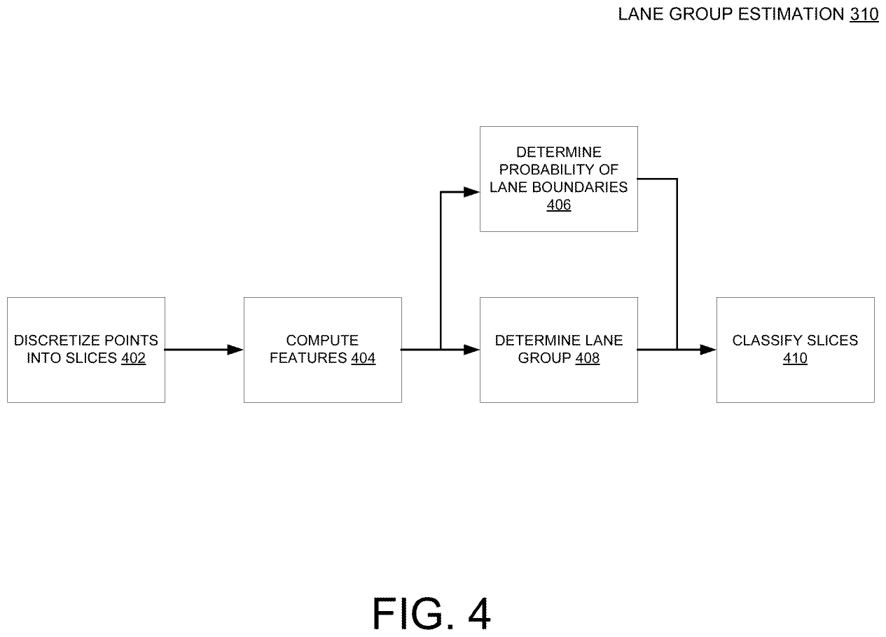

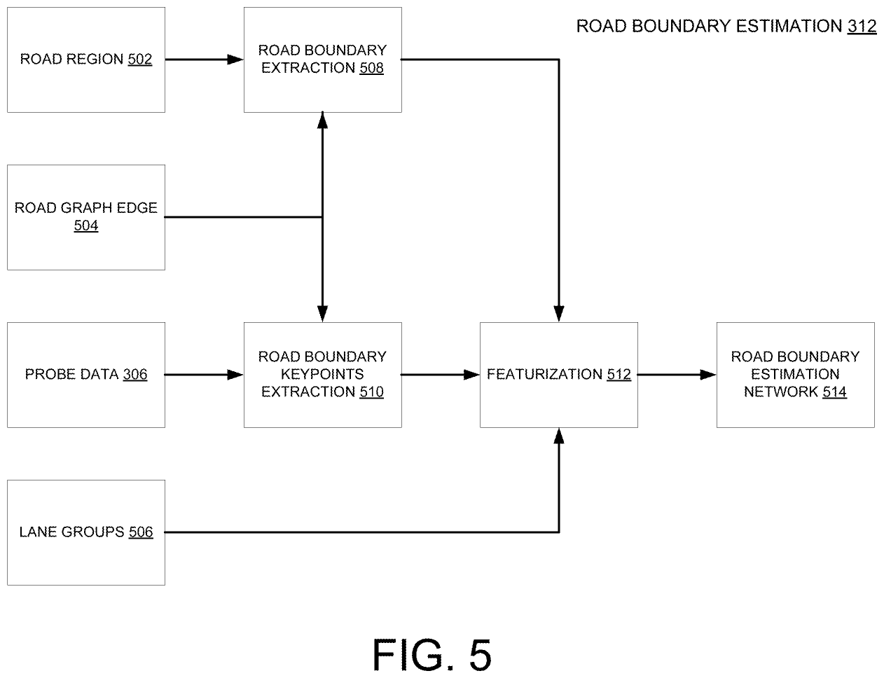

FIG. 3 illustrates an example system for estimating drivable surfaces. FIG. 3 will be described in conjunction with FIGS. 4 and 5, which illustrate aspects of FIG. 3 in additional detail. At blocks 302-306, the system can receive satellite data, road/navigation data, and vehicle probe data. Satellite data can include image and/or video data of the road from a bird's eye viewpoint. As described above, road/navigation data can include any mapping of the road with relevant characteristics such as lane markings, road shape, traffic data, and/or other infrastructure data. The system can perform road extraction 308 based on the satellite imagery. Here, road extraction refers to any technique to isolate the imagery of the road from the satellite imagery. The road extraction, navigation map, and probe data can be used to execute lane group estimation 310, illustrated in FIG. 4.

As illustrated in FIG. 4, the system can discretize points/locations into road slices at block 402. Here, a road slice or segment can refer to any lateral segment of road. In some embodiments, the road can be divided into five-meter-long slices. In some embodiments, these slices can be compressed into a one-dimensional histogram. Each slice can be associated with various road features based on the road map and/or probe data. For example, data can indicate adjacent slices, confidence, distance from vehicle, boundary type, lane offset, surface type, and/or time of day. At block 404, the system can compute road features based on the discretized slices. As described above, features can include, but are not limited to, boundaries, road surface, lane surface, lane type, or lane direction. Features can be determined based on the information associated with each road slice. The system can also be trained to learn additional or existing features based on annotated data. In some embodiments, featurizing the data includes separately counting for each lateral bin of a slice how many data points (i.e., detection points) are present. Detection points can be associated with various road aspects including road surface, lane type, lane direction, etc. As the vehicle traverses the roadway, the system can update based on the relevant features depending on the vehicle's trajectory. For example, at one section of the road, the drivable surface is marked by physical lane markings. At a second section of the road, the drivable surface can be marked by a physical barrier. The system can take the differences into account and continuously update to learn appropriate features.

At block 406, the system can determine a probability of lane boundaries for various points of each road slice. Probabilities may be associated with a confidence value. Lane boundaries can include hard boundaries or soft boundaries. Here, hard boundaries refer to a road boundary detected with a high confidence value. High confidences may be attributed because of lane markings, physical road barriers, or any other clear boundary. Soft boundaries can refer to the system's estimation of a road boundary based on the surrounding road. For example, there may be a break in the road where the vehicle can turn left. The system can estimate a soft lane boundary based on the previous and upcoming slices. Soft lane boundaries may inform an autonomous vehicle that it can traverse through the soft lane boundary in certain situations, i.e., to make a turn, pass an oncoming vehicle, etc. Soft boundaries may also be attributed a lower confidence value depending on the available data. For example, there may be lane markings covered with snow on the road, such that the system may still detect the lane boundary but at a lower confidence based on the received data.

At block 408, the system can make lane group estimations based on the computed features. The system can apply a CNN network to make these determinations. Lane groups can group road slices based on various characteristics and similarities between the road slices. For instance, one lane group may be associated with roadway including four full available lanes. One lane group may indicate a transition in the road from four lanes to three lanes, where a lane gets smaller until it merges with another lane. Another lane group may illustrate a section where a lane isn't available due to traffic cones and/or construction. Any similarities in the road slices can be applied to form one or more lane groups. In some embodiments, the system may determine lane groups by evaluating a number of neighboring slices to determine if a road slice is a lane group boundary. A lane group boundary can indicate the start or end of a lane group. Lane group boundaries can be indicated with a binary classification.

At block 410, the lane boundary probabilities and lane groups can be applied to classify each road slice. Each road slice can be classified to include its estimated lane boundaries and corresponding lane group. Classifications can include but are not limited to how each slice relates to the lane group. For instance, one road slice may be the start of a lane group, the continuation of a lane group, the end of a lane group, the intersection of a lane group, etc. Classifications may be displayed in vehicle to a driver while the vehicle is in operation. The display may include a map illustrating the different lane groups, changes in lane groups, or other classification features.

In some embodiments, lane group estimation 310 is not included in the system illustrated in FIG. 2. In this case, the data and road extraction can be input directly into road boundary estimation network 312. However, road boundary estimation network 312 may provide more accurate and detailed mapping with the inclusion of lane groups. In the case of FIG. 3, information regarding the classifications for each road slice can be input into road boundary estimation network 312. Road boundary estimation network 312 is illustrated in FIG. 5.

At block 508, road boundaries can be extracted from road region data 502 and road graph edge data 504. Road region 502 may include satellite imagery as illustrated in FIG. 3. Road graph edge data can include mappings of the roadway including a plurality of nodes separating pieces of the roadway. Road graph edge data can include road and navigation data 304. This data can be used to find related road boundary polylines for specific road graph edges. These polylines, i.e., illustrative road markings, can approximate the road edge.

Concurrently, as block 510, the system can extract road boundary key points with the inclusion of probe data 306. As described above, key points can refer to identified locations of the road edge as generated by the extraction network based on one or more road characteristics. Each key point can indicate characteristics such as lane boundary, road type, road surface, lane type, etc. Road boundary extraction 508 and road boundary key points extraction 510 can be featurized at block 512 with or without the addition of lane groups 506.

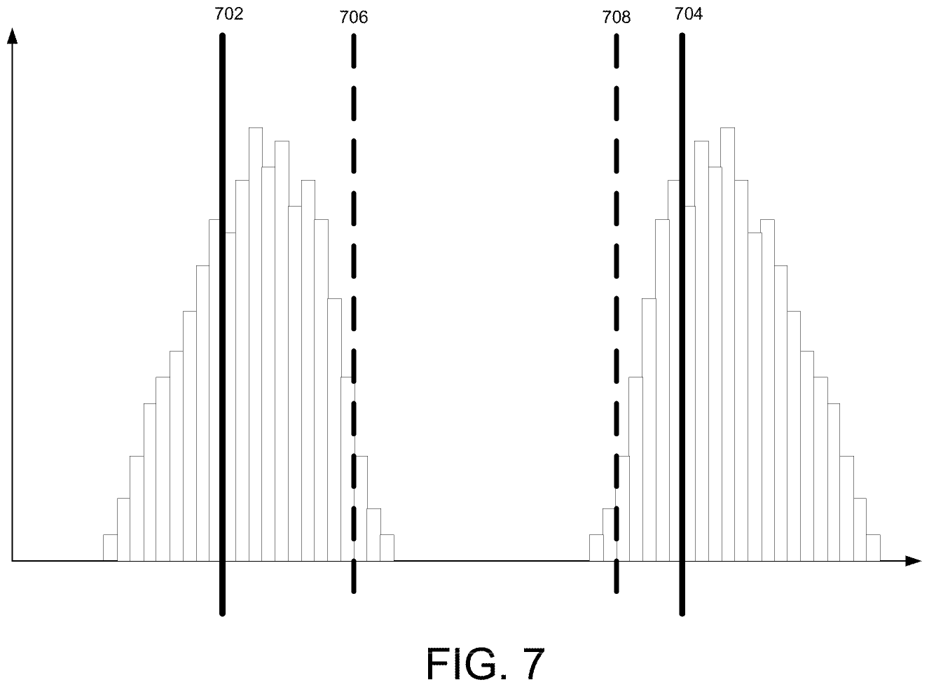

At block 512, featurization can involve creating a feature set from road boundaries, key points, and lane groups. This feature set can include positions of left and right boundaries on the road and/or the leftmost and rightmost lane boundary. The feature set can include a histogram of road boundary key points based on divisions of each road slice. For a lane group, the system can iterate over road graph edges and then iterate over lane groups on each and every edge to generate this histogram. An example of a feature set is illustrated below in FIG. 7.

At block 514, the system can generate a road boundary estimation network that estimates road boundaries as the vehicle traverses the roadway. This road boundary estimation network can be used to generate map 314 as illustrated in FIG. 3. Similar to the display mentioned above in FIG. 4, map 314 can be displayed in vehicle to illustrate the drivable surfaces. Internally, map 314 can be used by the autonomous driving system to plot trajectories and maneuvers based on the upcoming roadway. Map 314 can update at certain time intervals or over various distances as needed.

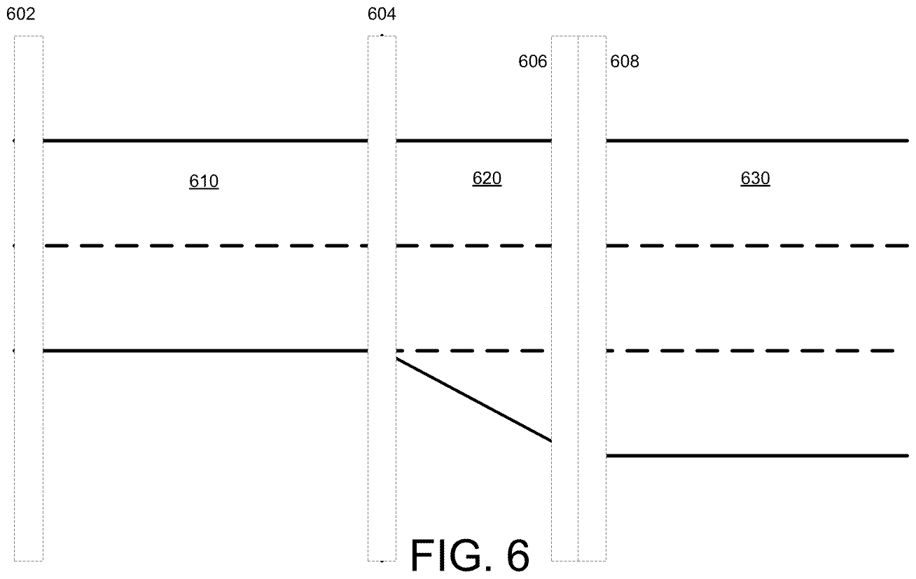

FIG. 6 illustrates an example of three lane groups 610, 620, and 630 on a roadway. As described above, the roadway may be divided into five-meter slices. Each slice can be evaluated and classified based on its relationship to the lane group. In the example of FIG. 6, slice 602 can be classified as the start of lane group 610. Lane group 610 may be characterized by the presence of two available lanes. As described above, lane boundaries may be denoted by lane markings, physical barriers, construction sites, or any other obstacles sectioning the road. Slice 604 can be categorized as the end of lane group 610 and the start of lane group 620. In some embodiments, a slice may be only the start or only the end of a lane group. In other embodiments, a slice may be classified as part of multiple lane groups. Such slices may illustrate transitions between lane groups. Here, lane group 620 can illustrate the portion of the road where a third lane is opening up. Slice 606 can be categorized as the end of lane group 620. Subsequent slice 608 can signify the start of lane group 630. In the example of slices 606 and 608, there may be no transition between lane groups 620 and 630. Lane group 630 can illustrate a section of road where three lanes are available. The system may treat the solid lines as hard boundaries, and the dotted lines as soft boundaries.

FIG. 7 illustrates an example histogram feature set of a road slice. The histogram can comprise a plurality of lateral bins for each road boundary key point indicating a probability of a road boundary. In the example of FIG. 7, lines 702 and 708 can illustrate the road boundaries as determined by satellite imagery or other image-based data. Lines 706 and 708 can illustrate the leftmost and rightmost lane boundaries as determined by road boundary estimation network. As illustrated in FIG. 7, the leftmost and rightmost lane boundaries may not be the same as the image-based road boundaries.

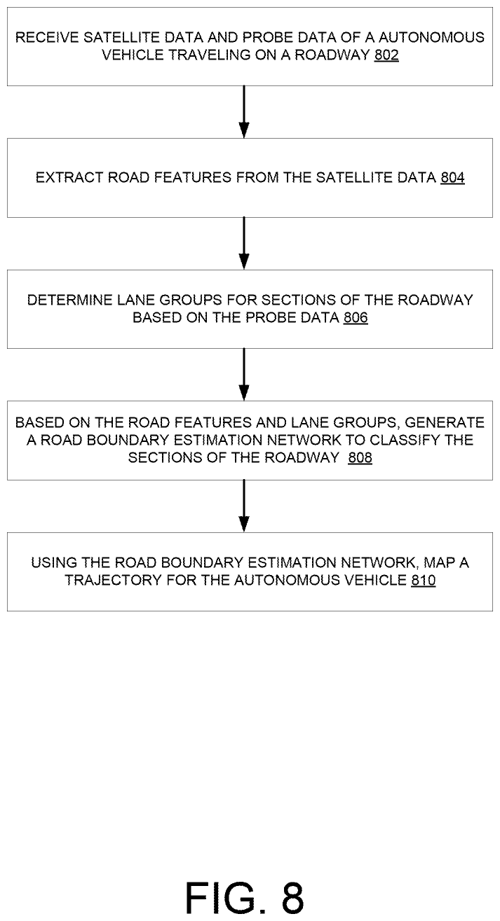

FIG. 8 illustrates an example method for determining the trajectory of an autonomous vehicle. At block 802, the system can receive satellite data and probe data of an autonomous vehicle travelling on a roadway. At block 804, the system can extract road features from the satellite data. Road features can include road boundaries and road key points. As described above, key points can refer to identified locations of the road edge as generated by the extraction network based on one or more road characteristics. Each key point can indicate characteristics such as lane boundary, road type, road surface, lane type, etc.

At block 806, the system can determine lane groups for sections of the road based on the probe data. As described in FIG. 4, the system can discretize points/locations into road slices. Each slice can be associated with various road features based on the road map and/or probe data. For example, data can indicate adjacent slices, confidence, distance from vehicle, boundary type, lane offset, surface type, and/or time of day. The system can compute road features based on the discretized slices. Based on these road features, a probability of lane boundaries can be determined for various points of each road slice. Probabilities may be associated with a confidence value. These lane boundaries can be used to create lane groups that group road slices based on various characteristics and similarities between the road slices. Any similarities in the road slices can be applied to form one or more lane groups. In some embodiments, the system may determine lane groups by evaluating a number of neighboring slices to determine if a road slice is a lane group boundary. Lane group boundaries can be indicated with a binary classification. The lane boundary probabilities and lane groups can be applied to classify each road slice. Each road slice can be classified to include its estimated lane boundaries and corresponding lane group.

At block 808, based on the road features and lane groups, the system can generate a road boundary estimation network to classify sections of the roadway. As described above, the road boundary estimation network can estimate road boundaries as the vehicle traverses the roadway. This road boundary estimation network can be used to generate a map which can be displayed in vehicle to illustrate the drivable surfaces. Internally, the map can be used by the autonomous driving system to plot trajectories and maneuvers based on the upcoming roadway. Accordingly, at block 810, using the road boundary estimation network, the system can map a trajectory for the autonomous vehicle.

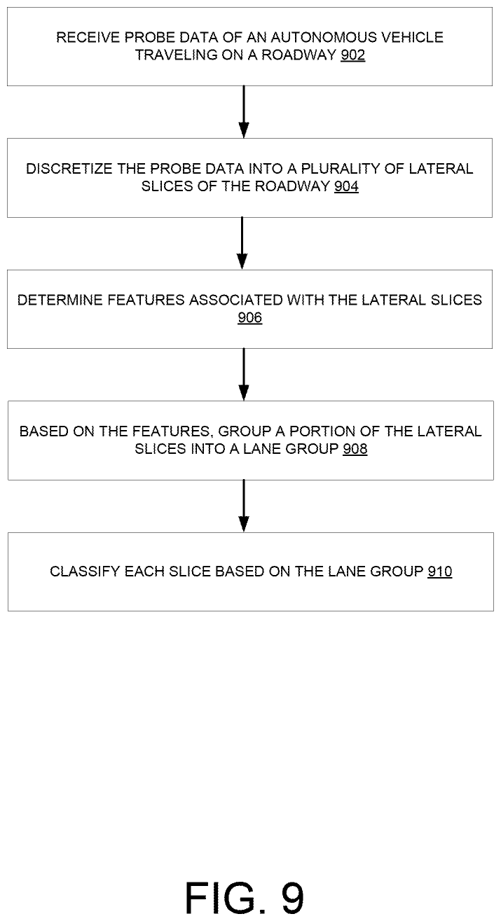

FIG. 9 illustrates an example method for classifying road segments based on lane groups. At block 902, the system can receive probe data of an autonomous vehicle traveling on a roadway. Here, a probe data can refer to data received from the vehicle or surrounding vehicles of the roadway based on the vehicle's sensors. At block 904, the system can discretize the probe data into a plurality of lateral slices of the roadway. As described above, in some embodiments, the slices may comprise five-meter lateral slices of the roadway.

At block 906, the system can determine features associated with the lateral slices. As described above, features can include, but are not limited to, boundaries, road surface, lane surface, lane type, or lane direction. Features can be determined based on the information associated with each road slice. The system can also be trained to learn additional or existing features based on annotated data.

At block 908, the system can group a portion of the lateral slices into a lane group based on the features. As described above, lane groups can group road slices based on various characteristics and similarities between the road slices. Any similarities in the road slices can be applied to form one or more lane groups. In some embodiments, the system may determine lane groups by evaluating a number of neighboring slices to determine if a road slice is a lane group boundary. Lane group boundaries can be indicated with a binary classification.

At block 910, the system can classify each road slice based on the lane groups. Each road slice can be classified to include its estimated lane boundaries and corresponding lane group. Classifications can include but are not limited to how each slice relates to the lane group. For instance, one road slice may be the start of a lane group, the interior of a lane group, the end of a lane group, the intersection of a lane group, etc. Classifications may be displayed in vehicle to a driver while the vehicle is in operation. The display may include a map illustrating the different lane groups, changes in lane groups, or other classification features.

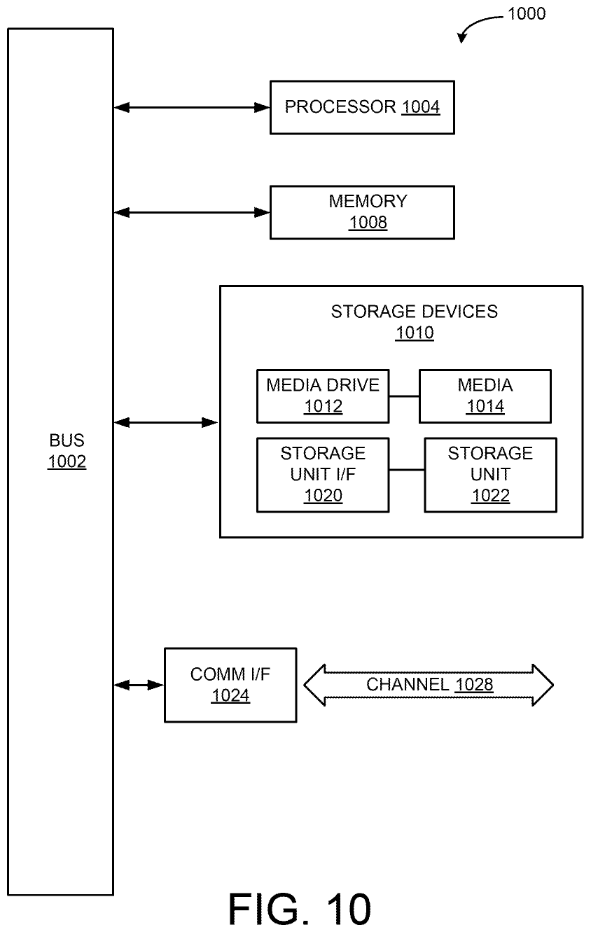

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionalities can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 10. Various embodiments are described in terms of this example-computing component 1000. After reading this description, it will become apparent to a person skilled in the relevant art how to implement the application using other computing components or architectures.

Referring now to FIG. 10, computing component 1000 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 1000 might also represent computing capabilities embedded within or otherwise available to a given device. For example, a computing component might be found in other electronic devices such as, for example, portable computing devices, and other electronic devices that might include some form of processing capability.

Computing component 1000 might include, for example, one or more processors, controllers, control components, or other processing devices. Processor 1004 might be implemented using a general-purpose or special-purpose processing engine such as, for example, a microprocessor, controller, or other control logic. Processor 1004 may be connected to a bus 1002. However, any communication medium can be used to facilitate interaction with other components of computing component 1000 or to communicate externally.

Computing component 1000 might also include one or more memory components, simply referred to herein as main memory 1008. For example, random access memory (RAM) or other dynamic memory, might be used for storing information and instructions to be executed by processor 1004. Main memory 1008 might also be used for storing temporary variables or other intermediate information during execution of instructions to be executed by processor 1004. Computing component 1000 might likewise include a read only memory (“ROM”) or other static storage device coupled to bus 1002 for storing static information and instructions for processor 1004.

The computing component 1000 might also include one or more various forms of information storage mechanism 1010, which might include, for example, a media drive 1012 and a storage unit interface 1020. The media drive 1012 might include a drive or other mechanism to support fixed or removable storage media 1014. For example, a hard disk drive, a solid-state drive, a magnetic tape drive, an optical drive, a compact disc (CD) or digital video disc (DVD) drive (R or RW), or other removable or fixed media drive might be provided. Storage media 1014 might include, for example, a hard disk, an integrated circuit assembly, magnetic tape, cartridge, optical disk, a CD or DVD. Storage media 1014 may be any other fixed or removable medium that is read by, written to or accessed by media drive 1012. As these examples illustrate, the storage media 1014 can include a computer usable storage medium having stored therein computer software or data.

In alternative embodiments, information storage mechanism 1010 might include other similar instrumentalities for allowing computer programs or other instructions or data to be loaded into computing component 1000. Such instrumentalities might include, for example, a fixed or removable storage unit 1022 and an interface 1020. Examples of such storage units 1022 and interfaces 1020 can include a program cartridge and cartridge interface, a removable memory (for example, a flash memory or other removable memory component) and memory slot. Other examples may include a PCMCIA slot and card, and other fixed or removable storage units 1022 and interfaces 1020 that allow software and data to be transferred from storage unit 1022 to computing component 1000.

Computing component 1000 might also include a communications interface 1024. Communications interface 1024 might be used to allow software and data to be transferred between computing component 1000 and external devices. Examples of communications interface 1024 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 1024 may be carried on signals, which can be electronic, electromagnetic (which includes optical) or other signals capable of being exchanged by a given communications interface 1024. These signals might be provided to communications interface 1024 via a channel 1028. Channel 1028 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 1008, storage unit 1020, media 1014, and channel 1028. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 1000 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
receiving probe data of an autonomous vehicle traveling on a roadway;
discretizing the probe data into a plurality of lateral slices of the roadway;
determining features associated with the plurality of lateral slices;
grouping a portion of the plurality of lateral slices into a lane group based on the features; and
classifying each slice based on the lane group.

2. The method of claim 1, wherein a CNN network groups the portion of the plurality of lateral slices into the lane group.

3. The method of claim 1, wherein the probe data generates a histogram indicating probabilities of lane boundaries across the plurality of lateral slices.

4. The method of claim 1, wherein each lateral slice comprises five meters of the roadway.

5. The method of claim 1, wherein each slice of the portion of the plurality of lateral slices is classified as a start of the lane group, an interior of the lane group, or an end of the lane group.

6. The method of claim 1, wherein the features comprise hard lane boundaries and soft lane boundaries.

7. The method of claim 1, further comprising determining that a slice of the plurality of lateral slices classifies as a transition between lane groups.

8. The method of claim 1, wherein each lane group comprises a left and right road boundary.

9. A vehicle control system, comprising:
a processor; and
a memory coupled to the processor to store instructions, which when executed by the processor, cause the processor to:
receive probe data of an autonomous vehicle traveling on a roadway;
discretize the probe data into a plurality of lateral slices of the roadway;
generating a histogram indicating probabilities of lane boundaries across the plurality of lateral slices;
group a portion of the plurality of lateral slices into a lane group based on the histogram; and
classify each slice based on the lane group.

10. The vehicle control system of claim 9, wherein a CNN network groups the portion of the plurality of lateral slices into the lane group.

11. The vehicle control system of claim 9, wherein each lateral slice of the plurality of lateral slices comprises five meters of the roadway.

12. The vehicle control system of claim 9, wherein each slice of the portion of the plurality of lateral slices is classified as a start of the lane group, an interior of the lane group, or an end of the lane group.

13. The vehicle control system of claim 9, wherein the instructions further cause the processor to determine that a slice of the plurality of lateral slices classifies as a transition between lane groups.

14. The vehicle control system of claim 9, wherein each lane group comprises a left and right road boundary.

15. A non-transitory machine-readable medium having instructions stored therein, which when executed by a processor, cause the processor to:
receive probe data of an autonomous vehicle traveling on a roadway;
discretize the probe data into a plurality of lateral slices of the roadway;
determine features associated with the plurality of lateral slices;
group a portion of the plurality of lateral slices into a lane group based on the features; and
determine that one or more slices of the plurality of lateral slices classifies as transitions between lane groups.

16. The non-transitory machine-readable medium of claim 15, wherein a CNN network groups the portion of the plurality of lateral slices into the lane group.

17. The non-transitory machine-readable medium of claim 15, wherein the probe data generates a histogram indicating probabilities of lane boundaries across the plurality of lateral slices.

18. The non-transitory machine-readable medium of claim 15, wherein each lateral slice comprises five meters of the roadway.

19. The non-transitory machine-readable medium of claim 15, wherein the features comprise hard lane boundaries and soft lane boundaries.

20. The non-transitory machine-readable medium of claim 15, wherein each lane group comprises a left and right road boundary.
